(19) United States
(12) Patent Application Publication
(10) Pub. No.: US 2003/0023977 A1
(43) Pub. Date: Jan. 30, 2003

(54) Presentation of automated personalized television programming with preference notations using a wireless hand-held computing device

(76) Inventors: William P. Brown, Corvallis, OR (US); Joseph Jacob, San Francisco, CA (US); Charlie Udom, Albany, OR (US)

Correspondence Address: HEWLETT-PACKARD COMPANY, Intellectual Property Administration, P.O. Box 272400, Fort Collins, CO, 80527-2400, US

(21) Appl. No.: 09/917,010

(22) Filed: Jul. 26, 2001

(51) Int. Cl. H04N 5/445

(52) U.S. Cl. 725/58; 725/53; 725/46

(57) ABSTRACT

The present invention provides a method and wireless hand-held computing device for providing personalized, wireless television programming together with program information for programs matching the viewer's preferences. In one embodiment the method includes receiving programming codes in combination with corresponding television programming information and inputting, by a viewer, names of selected programs for viewing. Then, programming software in the wireless hand-held computing device may be used to select, automatically, the programming codes for the selected programs for viewing, to activate the television when the selected programs are broadcast and, where desired, to indicate when at least one television program that matches the viewer's preferences is to be shown.

### FIELD OF THE INVENTION

The invention relates generally to providing automated personalized television programming and, more particularly, to providing automated personalized television programming with suggestions of programming corresponding to preferences.

### BACKGROUND OF THE INVENTION

Television guides are well-known. Such guides are found in newspapers, television guide booklets, and as grids on television screens so that viewers may see what time each program is being broadcast. Cable television listings as well as public television listings are available on certain television channels. By inputting their zip codes, the viewers of such broadcasts can see channel numbers and call letters for the broadcast, cable and satellite programming in their areas. Some television guides provide summaries of programs, the type of program being presented, the leading actors and actresses in the televised movies, weather, news, special broadcasts, bulletin boards, documentaries, and the like.

Some of the guides are customizable, allowing the viewers to list programs that they prefer so that they can see more efficiently what is available for viewing at the times they are available. Thus, video cassette recorders (VCRs) may be programmed to record the viewer's favorite programs when he is not available to be home to watch them. Also, some televisions are programmable to record the viewer's favorite programs for later viewing.

However, there is no hand-held computing device for providing an electronic, personalized television program guide that alerts the viewer with regard to upcoming, preferred programs, simultaneously suggests programming based on the viewer's prior viewing history, and automatically changes television channels and activates the television broadcast for the preselected programs. Thus, there is a need for a handheld computing device that activates the viewer's preselected programs automatically, alerts the viewer that the programs are on, and also advises the viewer concerning other programs that match the preferences of the viewer.

### SUMMARY OF THE INVENTION

The present invention provides method and apparatus for a viewer to implement personalized, wireless television programming together with receiving program information for programs matching the viewer's preferences using a wireless hand-held computing device. Programming codes are received in combination with corresponding television programming information and a viewer is enabled to input a name of a selected program for viewing. Then the wireless hand-held computing device is utilized to select, automatically, the programming code for the selected program for viewing and to activate the television when the selected program is broadcast.

### BRIEF DESCRIPTION OF THE DRAWINGS

The foregoing advantages and features of the invention will become apparent upon reference to the following detailed description and the accompanying drawings, of which:

FIG. 1 is a flow chart of one embodiment of steps in accordance with a method of the present invention.

FIG. 2 is a flow chart of another embodiment of steps in accordance with a method of the present invention.

FIG. 3 is a block diagram of one embodiment of a wireless hand-held computing device in accordance with the present invention.

FIG. 4 is a block diagram of another embodiment of a wireless handheld computing device in accordance with the present invention.

### DETAILED DESCRIPTION OF SPECIFIC EMBODIMENTS

The present invention provides for delivering cable and public television programming listings to a wireless hand-held device, where the listings include programming codes such as, for example, VCR Plus codes, embedded therein so that the wireless hand-held device may readily combine the listing information with wireless programming capabilities to allow the viewer to create personalized television programming. Tracking and forecasting software may be used to determine historical patterns of television watching by the viewer, allowing the software to select other programs that may be of interest to the viewer and to bring them to his attention. For example, names of favorite actors or actresses such as “John Wayne” may be used as key words. In addition, programs may be categorized as to type. For example, “game shows” may be the type of programs preferred by the viewer. Since the viewing preferences are stored locally on the hand-held device, the user's privacy is not violated.

The remote wireless programming of the invention allows the user to change, automatically, a television channel in accordance with programs being broadcast that meet his preferences. For example, Omni Remote® may be used for wireless television programming of the Palm®) series of hand-held devices, the Handspring® handheld devices, or the like. The programming codes embedded in the television listings allow software to identify the desired programs selected by the viewer so that the desired channel is determined. As the viewer watches programs, the tracking and forecasting software is recording his history of programs watched.

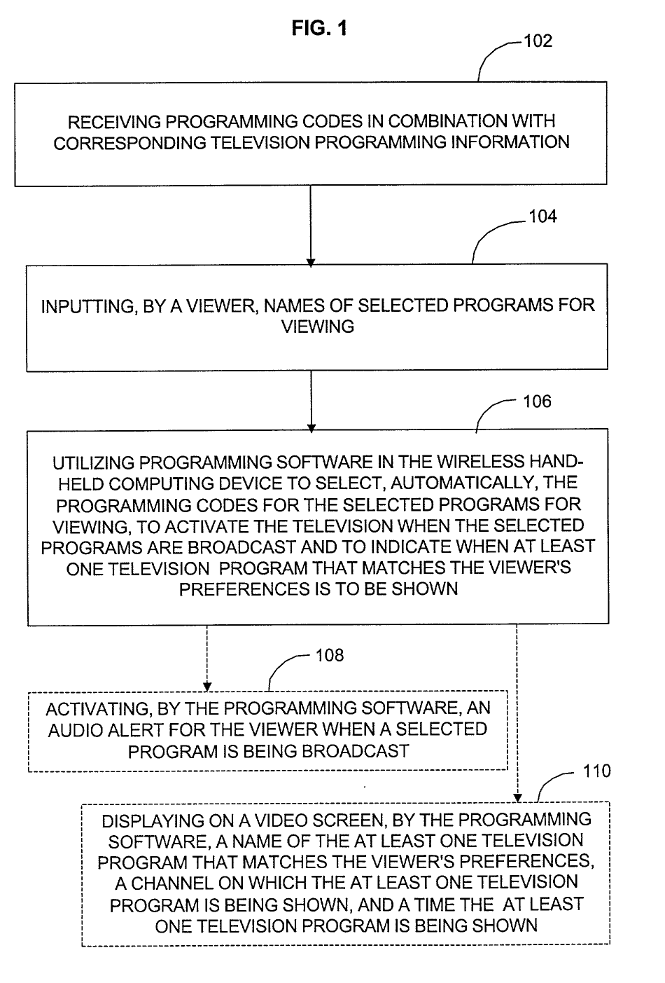

As shown in FIG. 1, one embodiment of a method for providing personalized, wireless television programming together with program information for programs matching the viewer's preferences using a wireless hand-held computing device in accordance with the present invention includes receiving 102 programming codes in combination with corresponding television programming information, inputting 104, by a viewer, names of selected programs for viewing, and utilizing 106 programming software in the wireless hand-held computing device to select, automatically, the programming codes for the selected programs for viewing, to activate the television when the selected programs are broadcast and to indicate when at least one television program that matches the viewer's preferences is to be shown. For example, VCR plus codes may be used to program a video cassette recorder that will then activate the television when the desired programs are broadcast.

The method may further include activating 108, by the programming software, an audio alert for the viewer when a selected program is being broadcast. The method may also include displaying 110 on a video screen, by the programming software, a name of the at least one television program that matches the viewer's preferences, a channel on which the at least one television program is being shown, and a time the at least one television program is being shown. Typically, the video screen is located on the wireless hand-held computing device or on a television that is showing a program the viewer has selected for viewing. The video screen may, for example, be a picture-in-picture on the television. In another embodiment, the video screen may be a screen of the television and information for the at least one television program that matches the viewer's preferences may be shown immediately prior to the program selected by the viewer.

The programming software may include tracking and forecasting software in the wireless hand-held computer to record names of programs watched by the viewer, which are then used to forecast preferences of the viewer based on the names of programs watched by the viewer.

The programming software may also include tracking and forecasting software in the wireless hand-held computer to record types of programs watched by the viewer. Then, the tracking and forecasting software may be used to forecast preferences of the viewer based on the types of programs watched by the viewer.

The programming software may include tracking and forecasting software in the wireless hand-held computer to record keywords for programs watched by the viewer, then forecasting preferences of the viewer based on the keywords of programs watched by the viewer.

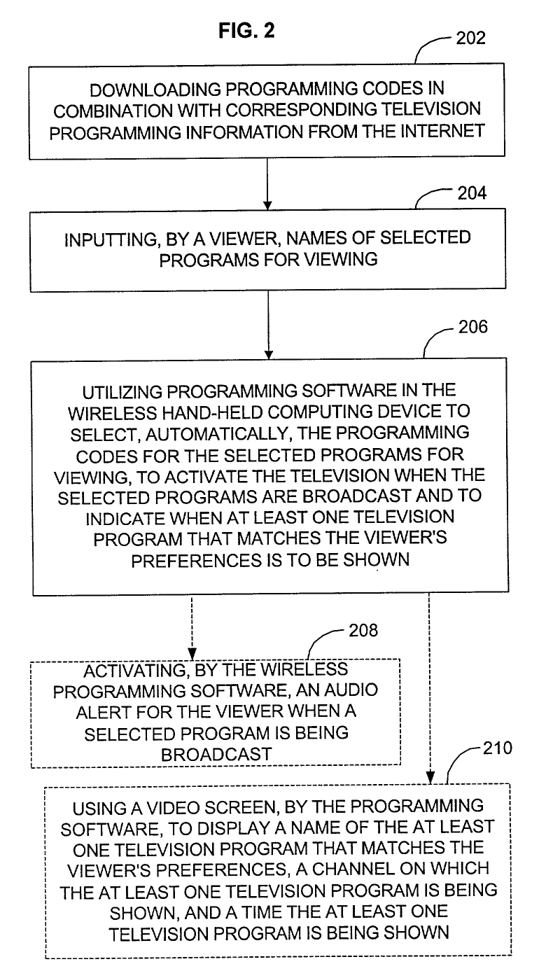

As shown in FIG. 2, another embodiment of a method for providing personalized, wireless television programming together with program information for programs matching the viewer's preferences using a wireless hand-held computing device in accordance with the present invention includes the steps of downloading 202 programming codes in combination with corresponding television programming information from the Internet, inputting 204, by a viewer, names of selected programs for viewing, and utilizing 206 programming software in the wireless hand-held computing device to select, automatically, the programming codes for the selected programs for viewing, to activate the television when the selected programs are broadcast and to indicate when at least one television program that matches the viewer's preferences is to be shown. The method may also include activating 208, by the programming software, an audio alert for the viewer when a selected program is being broadcast. A video screen may be used, by the programming software, to display 210 a name of the at least one television program that matches the viewer's preferences, a channel on which the at least one television program is being shown, and a time the at least one television program is being shown. Generally, the video screen is located on the wireless hand-held computing device or on a television that is showing a program the viewer has selected for viewing. The video screen may be a picture-in-picture on the television, or alternatively, the video screen may be a screen of the television and information for the at least one television program that matches the viewer's preferences is shown immediately prior to the program selected by the viewer.

Tracking and forecasting software in the programming software of the wireless hand-held computer may be used to record names of programs watched by the viewer, and the names may be used to forecast preferences of the viewer based on the names of programs watched by the viewer.

The tracking and forecasting software in the programming software of the wireless hand-held computer may also be used to record types of programs watched by the viewer. Then the types of programs may be used to forecast preferences of the viewer based on the types of programs watched by the viewer.

Also, the programming software may include tracking and forecasting software in the wireless hand-held computer to record keywords for programs watched by the viewer and to forecast preferences of the viewer based on the keywords of programs watched by the viewer.

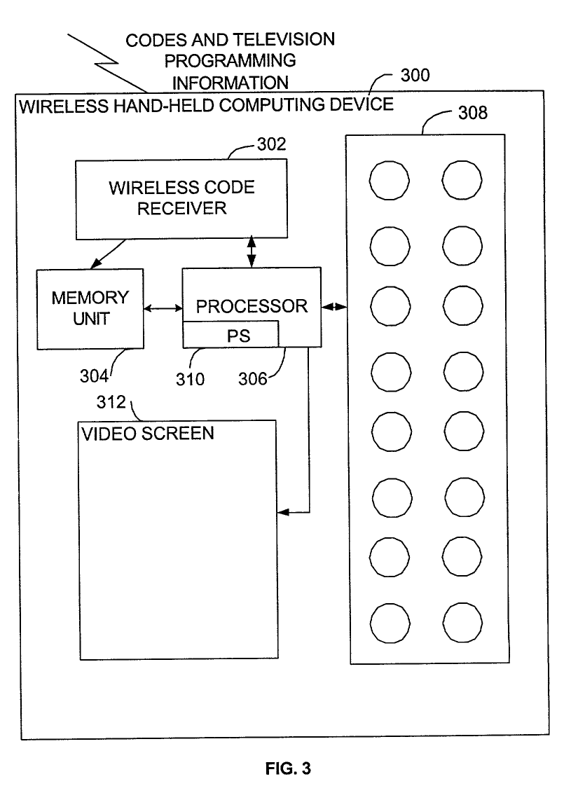

FIG. 3 is a block diagram showing one embodiment of a wireless handheld computing device 300 arranged for providing personalized, wireless television programming together with, where desired, program information for programs matching the viewer's preferences in accordance with the present invention. The device 300 includes a wireless code receiver 302 that is arranged to receive programming codes in combination with corresponding television programming information and to send said codes and said programming information to a memory unit 304 coupled to a processor 306. A plurality of programming input buttons 308, coupled to the processor 306, are used for inputting, by a viewer, names of selected programs for viewing. Programming software (PS) 310 is loaded in the processor 306 and is used for selecting, automatically, the programming codes, such as, for example, video cassette recorder plus codes, for the selected programs for viewing, automatically activating the television when the selected programs are broadcast and for, where desired, providing an indication when at least one television program that matches the viewer's preferences is to be shown. The processor 306 is coupled to the memory unit 304 and the plurality of programming buttons 308, with the programming software 310 loaded thereon, and implements the programming software 310. The programming software 310 may provide an audio alert for the viewer when a selected program is being broadcast, and may provide, on a video screen 312, a name of the at least one television program that matches the viewer's preferences, a channel on which the at least one television program is being shown, and a time the at least one television program is being shown. The video screen 312 may be located on the wireless hand-held computing device, or on a television that is showing a program the viewer has selected for viewing. For example, the video screen 312 may be a picture-in-picture on the television, or alternatively, the video screen 312 may be a screen of the television and information for the at least one television program that matches the viewer's preferences may be shown immediately prior to the program selected by the viewer. The programming software 310 may include tracking and forecasting software to record names of programs watched by the viewer, and may automatically forecast preferences of the viewer based on the names of programs watched by the viewer.

The programming software 310 may include tracking and forecasting software to record types of programs watched by the viewer and be arranged to forecast, automatically, preferences of the viewer based on the types of programs watched by the viewer. The programming software 310 may be wireless or hard-wired.

The programming software 310 may also include tracking and forecasting software to record keywords for programs watched by the viewer to forecast, automatically, preferences of the viewer based on the keywords of programs watched by the viewer.

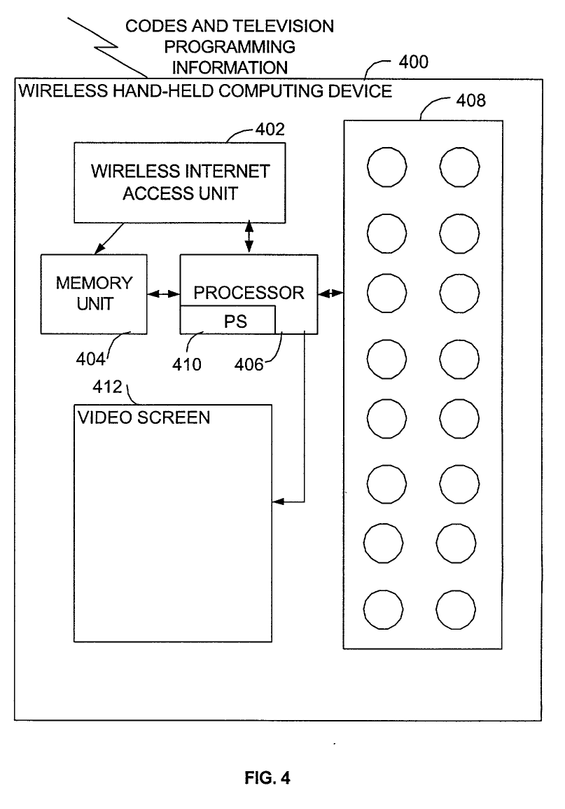

As shown in FIG. 4, another embodiment of a wireless hand-held computing device 400 in accordance with the present invention may include a wireless Internet access unit 402 that is arranged to provide for downloading programming codes in combination with corresponding television programming information from the Internet to a memory unit 404 that is coupled to a processor 406. A plurality of programming input buttons 408 are coupled to the processor 406 and provide for viewer input of names of selected programs for viewing. Programming software (PS) 410 is loaded in the processor 406 and is used to select, automatically, the programming codes, such as, for example, video cassette recorder plus codes or personal digital assistant codes for cable boxes, for the selected programs for viewing, to activate the television when the selected programs are broadcast and to indicate when at least one television program that matches the viewer's preferences is to be shown. Activation of the television may be accomplished by programming a video cassette recorder, a personal digital assistant or the like. The processor 406 is coupled to the memory unit 404 and the plurality of programming input buttons 408 and implements the programming software 410. Again, the programming software 410 may provide an audio alert for the viewer when a selected program is being broadcast and may implement a display on a video screen 412 a name of the at least one television program that matches the viewer's preferences, a channel on which the at least one television program is being shown, and a time the at least one television program is being shown.

The video screen 412 is typically located on the wireless hand-held computing device 400 or on a television 414 that is showing a program the viewer has selected for viewing. The video screen 412 may, for example, be a picture-in-picture on the television, or a screen of the television wherein information for the at least one television program that matches the viewer's preferences is shown immediately prior to the program selected by the viewer.

The programming software 410 may include tracking and forecasting software that records names of programs watched by the viewer and forecasts preferences of the viewer based on the names of programs watched by the viewer.

The programming software 410 may also include tracking and forecasting software that records types of programs watched by the viewer and forecasts preferences of the viewer based on the types of programs watched by the viewer.

Also, the programming software may include tracking and forecasting software in the wireless hand-held computer to record keywords for programs watched by the viewer and forecast preferences of the viewer based on the keywords of programs watched by the viewer.

Thus, a method and wireless hand-held computing device for providing remote personalized television programming along with suggested programs matching the viewer's preferences has been described according to the present invention.

We claim:

1. A method for providing personalized, wireless television programming together with program information for programs matching the viewer's preferences using a wireless hand-held computing device, comprising the steps of:
receiving programming codes in combination with corresponding television programming information;
inputting, by a viewer, a name of a selected program for viewing; and
utilizing the wireless hand-held computing device to select, automatically, the programming code for the selected program for viewing and to activate the television when the selected program is broadcast.

2. The method of claim 1 wherein the programming codes are video cassette recorder plus codes for programming a video cassette recorder to activate the television when the selected program is broadcast.

3. The method of claim 1 wherein the programming codes are codes for a personal digital assistant to use to program cable boxes.

4. The method of claim 1 wherein utilizing the wireless hand-held computing device includes utilizing programming software in the wireless hand-held computing device.

5. The method of claim 1 further including indicating, by the wireless hand-held computing device, when at least one television program that matches the viewer's preferences is to be shown.

6. The method of claim 4, further including activating, by the programming software, an audio alert for the viewer when a selected program is being broadcast.

7. The method of claim 1, further including displaying on a video screen, by the programming software, a name of the at least one television program that matches the viewer's preferences, a channel on which the at least one television program is being shown, and a time the at least one television program is being shown.

8. The method of claim 7 wherein the video screen is located on the wireless hand-held computing device.

9. The method of claim 7 wherein the video screen is located on a television that is showing a program the viewer has selected for viewing.

10. The method of claim 9 wherein the video screen is a picture-in-picture on the television.

11. The method of claim 7 wherein the video screen is a screen of the television and information for at least one television program that matches the viewer's preferences is shown immediately prior to the program selected by the viewer.

12. The method of claim 1 wherein utilizing the wireless hand-held computing device to select, automatically, the programming code for the selected program for viewing and to activate the television when the selected program is broadcast includes using tracking and forecasting software in the wireless hand-held computer for recording names of programs watched by the viewer.

13. The method of claim 12 wherein using the tracking and forecasting software in the programming software of the wireless hand-held computer includes forecasting preferences of the viewer based on the names of programs watched by the viewer.

14. The method of claim 12 wherein utilizing the wireless hand-held computing device to select, automatically, the programming code for the selected program for viewing and to activate the television when the selected program is broadcast includes using tracking and forecasting software in the wireless hand-held computer for recording types of programs watched by the viewer.

15. The method of claim 14 wherein using the tracking and forecasting software in the wireless hand-held computer includes forecasting preferences of the viewer based on the types of programs watched by the viewer.

16. The method of claim 12 wherein utilizing the wireless hand-held computing device to select, automatically, the programming code for the selected program for viewing and to activate the television when the selected program is broadcast includes using tracking and forecasting software in the wireless hand-held computer for recording keywords for programs watched by the viewer.

17. The method of claim 16 wherein using tracking and forecasting software in the wireless hand-held computer includes forecasting preferences of the viewer based on the keywords of programs watched by the viewer.

18. A method for providing personalized, wireless television programming together with program information for programs matching the viewer's preferences using a wireless hand-held computing device, comprising the steps of:
receiving video cassette recorder plus codes in combination with corresponding television programming information;
inputting, by a viewer, names of selected programs for viewing; and
utilizing programming software in the wireless hand-held computing device to select, automatically, the video cassette recorder plus codes for the selected programs for viewing, to program the video cassette recorder to activate the television when the selected programs are broadcast and to indicate when at least one television program that matches the viewer's preferences is to be shown.

19. The method of claim 18, further including activating, by the programming software, an audio alert for the viewer when a selected program is being broadcast.

20. The method of claim 18, further including displaying on a video screen, by the programming software, a name of the at least one television program that matches the viewer's preferences, a channel on which the at least one television program is being shown, and a time the at least one television program is being shown.

21. The method of claim 20 wherein the video screen is located on the wireless hand-held computing device.

22. The method of claim 20 wherein the video screen is located on a television that is showing a program the viewer has selected for viewing.

23. The method of claim 22 wherein the video screen is a picture-in-picture on the television.

24. The method of claim 22 wherein the video screen is a screen of the television and information for the at least one television program that matches the viewer's preferences is shown immediately prior to the program selected by the viewer.

25. The method of claim 18 wherein utilizing the programming software includes using tracking and forecasting software in the wireless hand-held computer for recording names of programs watched by the viewer.

26. The method of claim 25 wherein using the tracking and forecasting software in the programming software of the wireless hand-held computer includes forecasting preferences of the viewer based on the names of programs watched by the viewer.

27. The method of claim 18 wherein utilizing the programming software includes using tracking and forecasting software in the wireless hand-held computer for recording types of programs watched by the viewer.

28. The method of claim 27 wherein using the tracking and forecasting software in the wireless hand-held computer includes forecasting preferences of the viewer based on the types of programs watched by the viewer.

29. The method of claim 18 wherein utilizing the programming software includes using tracking and forecasting software in the wireless hand-held computer for recording keywords for programs watched by the viewer.

30. The method of claim 29 wherein using tracking and forecasting software in the wireless hand-held computer includes forecasting preferences of the viewer based on the keywords of programs watched by the viewer.

31. A method for providing personalized, wireless television programming together with program information for programs matching the viewer's preferences using a wireless hand-held computing device, comprising the steps of:
downloading programming codes in combination with corresponding television programming information from the Internet;
inputting, by a viewer, names of selected programs for viewing; and
utilizing programming software in the wireless hand-held computing device to select, automatically, the video cassette recorder plus codes for the selected programs for viewing, to program the video cassette recorder to activate the television when the selected programs are broadcast and to indicate when at least one television program that matches the viewer's preferences is to be shown.

32. The method of claim 31, further including activating, by the programming software, an audio alert for the viewer when a selected program is being broadcast.

33. The method of claim 31, further including displaying on a video screen, by the programming software, a name of the at least one television program that matches the viewer's preferences, a channel on which the at least one television program is being shown, and a time the at least one television program is being shown.

34. The method of claim 33 wherein the video screen is located on the wireless hand-held computing device.

35. The method of claim 33 wherein the video screen is located on a television that is showing a program the viewer has selected for viewing.

36. The method of claim 33 wherein the video screen is a picture-in-picture on the television.

37. The method of claim 33 wherein the video screen is a screen of the television and information for the at least one television program that matches the viewer's preferences is shown immediately prior to the program selected by the viewer.

38. The method of claim 31 wherein utilizing the programming software includes using tracking and forecasting software in the wireless hand-held computer for recording names of programs watched by the viewer.

39. The method of claim 38 wherein using tracking and forecasting software in the wireless hand-held computer includes forecasting preferences of the viewer based on the names of programs watched by the viewer.

40. The method of claim 31 wherein utilizing the programming software includes using tracking and forecasting software in the wireless hand-held computer for recording types of programs watched by the viewer.

41. The method of claim 38 wherein using tracking and forecasting software in the wireless hand-held computer includes forecasting preferences of the viewer based on the types of programs watched by the viewer.

42. The method of claim 31 wherein utilizing the programming software includes using tracking and forecasting software in the wireless hand-held computer for recording keywords for programs watched by the viewer.

43. The method of claim 42 wherein using tracking and forecasting software in the wireless hand-held computer includes forecasting preferences of the viewer based on the keywords of programs watched by the viewer.

44. A wireless hand-held computing device arranged for providing personalized, wireless television programming together with program information for programs matching the viewer's preferences, comprising:
a wireless code receiver, arranged to receive programming codes in combination with corresponding television programming information and to send said codes and said programming information to a memory unit coupled to a processor;
a plurality of programming input buttons, coupled to the processor, for inputting, by a viewer, names of selected programs for viewing;
programming software, loaded in the processor, for selecting, automatically, the programming codes for the selected programs for viewing, automatically activating the television when the selected programs are broadcast; and
the processor, coupled to the memory unit and the plurality of programming buttons, with the programming software loaded thereon, for utilizing the programming software.

45. The device of claim 44, wherein the programming codes are video cassette recorder plus codes for programming a video cassette recorder to activate the television when the selected programs are broadcast.

46. The device of claim 44 wherein the programming codes are codes for a personal digital assistant to use to program cable boxes.

47. The device of claim 44 wherein the wireless hand-held computing device includes programming software.

48. The device of claim 44 wherein the wireless hand-held computing device indicates when at least one television program that matches the viewer's preferences is to be shown.

49. The device of claim 44, wherein the programming software further provides an audio alert for the viewer when a selected program is being broadcast.

50. The device of claim 44, wherein the programming software provides, on a video screen, a name of the at least one television program that matches the viewer's preferences, a channel on which the at least one television program is being shown, and a time the at least one television program is being shown.

51. The device of claim 50 wherein the video screen is located on the wireless hand-held computing device.

52. The device of claim 50 wherein the video screen is located on a television that is showing a program the viewer has selected for viewing.

53. The device of claim 50 wherein the video screen is a picture-in-picture on the television.

54. The device of claim 50 wherein the video screen is a screen of the television and information for at least one television program that matches the viewer's preferences is shown immediately prior to the program selected by the viewer.

55. The device of claim 44 wherein the programming software includes tracking and forecasting software to record names of programs watched by the viewer.

56. The device of claim 55 wherein the tracking and forecasting software automatically forecasts preferences of the viewer based on the names of programs watched by the viewer.

57. The device of claim 44 wherein the programming software includes tracking and forecasting software to record types of programs watched by the viewer.

58. The device of claim 57 wherein the tracking and forecasting software automatically forecasts preferences of the viewer based on the types of programs watched by the viewer.

59. The device of claim 44 wherein the programming software includes tracking and forecasting software to record keywords for programs watched by the viewer.

60. The device of claim 59 wherein the tracking and forecasting software automatically forecasts preferences of the viewer based on the keywords of programs watched by the viewer.

61. A wireless hand-held computing device for providing personalized, wireless television programming together with program information for programs matching the viewer's preferences, comprising:
a wireless Internet access unit, arranged to provide for downloading programming codes in combination with corresponding television programming information from the Internet to a memory unit that is coupled to a processor;
a plurality of programming input buttons, coupled to the processor, inputting, by a viewer, names of selected programs for viewing;
programming software loaded in the processor, to select, automatically, programming codes for the selected programs for viewing, to activate the television when the selected programs are broadcast and to indicate when at least one television program that matches the viewer's preferences is to be shown; and
the processor, coupled to the memory unit and the plurality of programming input buttons, for utilizing the programming software.

62. The device of claim 61, wherein the programming codes are video cassette recorder plus codes for programming a video cassette recorder to activate the television when the selected programs are broadcast.

63. The device of claim 61 wherein the programming codes are codes for a personal digital assistant to use to program cable boxes.

64. The device of claim 61 wherein the wireless hand-held computing device indicates when at least one television program that matches the viewer's preferences is to be shown.

65. The device of claim 61, wherein the programming software provides an audio alert for the viewer when a selected program is being broadcast.

66. The device of claim 61, wherein the programming software displays on a video screen a name of the at least one television program that matches the viewer's preferences, a channel on which the at least one television program is being shown, and a time the at least one television program is being shown.

67. The device of claim 66 wherein the video screen is located on the wireless hand-held computing device.

68. The device of claim 66 wherein the video screen is located on a television that is showing a program the viewer has selected for viewing.

69. The device of claim 66 wherein the video screen is a picture-in-picture on the television.

70. The device of claim 66 wherein the video screen is a screen of the television and information for at least one television program that matches the viewer's preferences is shown immediately prior to the program selected by the viewer.

71. The device of claim 61 wherein the programming software includes tracking and forecasting software that records names of programs watched by the viewer.

72. The device of claim 71 wherein the programming software includes tracking and forecasting software to forecast preferences of the viewer based on the names of programs watched by the viewer.

73. The device of claim 61 wherein programming software includes tracking and forecasting software that records types of programs watched by the viewer.

74. The device of claim 73 wherein the tracking and forecasting software forecasts preferences of the viewer based on the types of programs watched by the viewer.

75. The device of claim 61 wherein the programming software includes tracking and forecasting software in the wireless hand-held computer to record keywords for programs watched by the viewer.

76. The device of claim 75 wherein the tracking and forecasting software forecasts preferences of the viewer based on the keywords of programs watched by the viewer.
